(19) United States
(12) Patent Application Publication
(10) Pub. No.: US 2013/0196703 A1
(43) Pub. Date: Aug. 1, 2013

(54) SYSTEM AND COMMUNICATION HUB FOR A PLURALITY OF MEDICAL DEVICES AND METHOD THEREFORE

(71) Applicants: Javaid Masoud, Shoreview, MN (US); Gregory J. Haubrich, Champlin, MN (US)

(72) Inventors: Javaid Masoud, Shoreview, MN (US); Gregory J. Haubrich, Champlin, MN (US)

(73) Assignee: Medtronic, Inc.

(21) Appl. No.: 13/364,081

(22) Filed: Feb. 1, 2012

(51) Int. Cl. H04W 72/10

(52) U.S. Cl. 455/512

(57) ABSTRACT

System, hub and method having medical devices configured to transmit communications containing information affecting priority of transmission of data from an associated one of the medical devices, a destination node and a communication hub. The communication hub is configured to receive the communications from the medical devices, determine a priority of transmission of the data from the communications based, at least in part, on the information affecting priority, and transmit the data from one of the medical devices by way of a network to the destination node in an order based, at least in part, on the priority of transmission.

### FIELD

The present invention relates generally to a system, hub and method configured to communicate with such medical devices and, more particularly, to such system, hub and method involving priority of transmission of data between and with a plurality of medical devices.

### BACKGROUND

Various locations and environments, and particularly clinical environments, incorporate multiple active medical devices. Sensors such as scales and blood pressure monitors are configured simply to obtain patient data. Therapy delivery devices, such as pacemakers, defibrillators and drug pumps, provide treatment to patients as well as, in many embodiments, monitor the condition of the patient with which they are associated. Interfacing devices provide communication with other medical devices to allow information downloads from such medical devices and the ability to program medical devices to suit the needs of the patients. Various other classes and types of active medical devices are also to be found in various locations.

Over the years, the communications systems for medical devices have developed. In the past, such medical devices tended to be limited either to wired communications or to wireless communications with ranges of only a matter of centimeters. Moreover, electronic networking tended not to be applied to medical devices in such environments.

Lately, however, active medical devices have begun to incorporate communication systems which support large-scale networking. Medical devices have been configured with relatively longer-distance wireless communications and other networking communications. Medical devices such as interfacing devices have been configured with networking software to facilitate communication between and among various medical devices. Connectivity to the Internet has permitted users to interface with medical devices from great distances.

### SUMMARY

However, as medical devices have both proliferated and developed ever more expansive communication capabilities, the need to manage information flows to and from the various medical devices has increased considerably. Certain medical devices, such as defibrillators, may need to communicate urgent messages of patient distress to medical professionals and patient caregivers. Other medical devices, such as weight scales, may provide information which is useful but with essentially no attendant urgency at all. But networking schemes as they have existed and been applied to medical environments may not be sensitive to basing the transmission of data on a priority of the data as the priority pertains to the importance of the data in a medical environment. Consequently, medical device networks as may be found in medical environments may not discriminate in data transmission between data indicating that a patient is experiencing sudden cardiac death and information indicating that the patient is of a particular weight. While clinical environments may ensure that the patient experiencing sudden cardiac death will nevertheless be treated safely, delays in data transmission may, at minimum, create situations of relative disorder and unnecessary stress to patients and medical professionals.

In view of such issues, a medical device networking system has been developed which bases the transmission of data from medical devices on a relative priority of the data being transmitted. A local hub in communicative contact with medical devices receives transmissions from the medical devices local to the hub. The hub is then configured to assess the data and determine a priority of the data which the hub has received and which is awaiting retransmission to the ultimate destination of the transmitted data. On the basis of the priority determination of the various pieces of data the hub has received, the hub is configured to transmit the data to the destination based on the priority so that relatively more important information is transmitted first while relatively less important information does not interfere with the transmission of the important data.

Beyond simple urgency of the data to be transmitted, priority for data transmission may incorporate additional information. Considerations of network capabilities and characteristics may also be incorporated, including factors such as the quality of the network resources, hardware resources such as battery life, security issues and, in the case of devices configured to communicate over various frequency bands having different costs and capabilities, what the cost of communicating immediately may be in comparison with delaying communication.

As a result, the hub may be configured, in the above example, to note that one set of data indicates that a patient is suffering from sudden cardiac death while another set of data is a weight scale reading. On the basis of this analysis, the hub may be configured to transmit the indication of sudden cardiac death first and transmit the weight scale reading only after the indication of sudden cardiac death has been transmitted. Such a scenario may function different from an interrupt-driven system, for instance, in that prioritization may occur at many relative levels and may produce ongoing reassessments of relative positioning as new data arrives. Consequently, if, while the hub is transmitting the sudden cardiac death information, new data arrives indicating that a patient has elevated blood pressure as well as a new weight scale reading, the blood pressure information may be prioritized ahead of the first weight scale reading while the second weight scale reading may be prioritized last. A prioritized queue may thus develop independent of any need to create interrupts or otherwise disrupt normal communication processes.

In an embodiment, a system comprises a plurality of medical devices configured to transmit a plurality of communications containing information affecting priority of transmission of data from an associated one of the plurality of medical devices, a destination node and a communication hub. The communication hub is configured to receive the plurality of communications from the plurality of medical devices, determine a priority of transmission of the data from the plurality of communications based, at least in part, on the information affecting priority, and transmit the data from one of the plurality of medical devices by way of a network to the destination node in an order based, at least in part, on the priority of transmission.

In an embodiment, at least one of the plurality of medical devices is an implantable medical device.

In an embodiment, at least one of the plurality of medical devices corresponds to more than one of a plurality of patients.

In an embodiment, at least some of the plurality of medical devices are implantable medical devices configured to be implanted in a plurality of patients, each implantable medical device being implanted in only one patient at a time.

In an embodiment, each of the plurality of patients is implanted with only one of the plurality of medical devices.

In an embodiment, at least one of the plurality of patients is implanted with more than one of the plurality of medical devices.

In an embodiment, the priority of transmission is based, at least in part, on an importance of communication of the data from each of the plurality of medical devices.

In an embodiment, the priority of transmission is based, at least in part, on a quality of a communication signal over which the communication hub transmits the data.

In an embodiment, the communication hub is configured to transmit a first communication signal having the quality of the communication signal and a second transmission after the first transmission, and wherein the priority of transmission is determined for the second transmission based on the quality of the first communication signal.

In an embodiment, the quality of the communication signal is based, at least in part, on a data rate of the communication signal.

In an embodiment, the quality of the communication signal is based, at least in part, on an available bandwidth of the communication signal.

In an embodiment, the quality of the communication signal is based, at least in part, on a communication capability of at least one of the plurality of medical devices.

In an embodiment, the quality of the communication signal is based, at least in part, on a communication capability of the communication hub.

In an embodiment, the priority of transmission is based, at least in part, on a type of the data.

In an embodiment, the type of the data is based, at least in part, on an urgency of the data.

In an embodiment, the urgency of the data is based, at least in part, on a user input.

In an embodiment, the urgency of the data is based, at least in part, on the destination node.

In an embodiment, the destination node is at least one of an emergency call center, an emergency responder and a medical facility.

In an embodiment, the priority of transmission is based, at least in part, on a quantity of the data.

In an embodiment, the communication hub is further configured to transmit only a subset of the data from the one of the plurality of medical devices based on the priority of transmission.

In an embodiment, the priority of transmission is based, at least in part, on available power.

In an embodiment, the available power is based, at least in part, on an amount of power in a battery of a corresponding one of the plurality of medical devices.

In an embodiment, the priority of transmission is based, at least in part, on an authorization of a sender of the plurality of communications.

In an embodiment, the priority of transmission is based, at least in part, on a security of the plurality of communications.

In an embodiment, the plurality of communications are at least one of electronic mail, electronic text and audio.

In an embodiment, the plurality of communications include, at least in part, an alert message.

In an embodiment, the destination node is associated with at least one of an acquaintance of a patient associated with at least one of the plurality of medical devices and a medical professional associated with the patient, and the alert message is provided to the destination node.

In an embodiment, the alert message provides an identification of a sender of the alert message.

In an embodiment, the plurality of communications include at least one of an electrogram, blood pressure of a patient associated with at least one of the plurality of medical devices, a blood glucose level of the patient and a weight of the patient.

In an embodiment, the plurality of communications include at least one of an identification of at least one of the plurality of medical devices and a manufacture of at least one of the plurality of medical devices.

In an embodiment, the destination node is configured to respond to the plurality of communications with at least one of a confirmation message and a command to alter a configuration of at least one of the plurality of medical devices.

In an embodiment, the command to alter the configuration of the at least one of the plurality of medical devices performs at least one of stopping a false alert message, stopping an improper therapy delivery and configuring the at least one of the plurality of medical devices in a safe mode.

In an embodiment, the safe mode is configured to protect, at least in part, the at least one of the plurality of medical devices from an environmental condition.

In an embodiment, the communication hub and the destination node are components of a network.

In an embodiment, the communication hub is a standalone external communication hub.

In an embodiment, the communication hub is a distributed external communication hub.

In an embodiment, the communication hub has a communication interface for transmitting the data comprising at least one of Bluetooth and WiFi.

In an embodiment, the communication hub changes the communication interface based on a type of the data.

In an embodiment, the communication hub changes the communication interface based on an urgency of the data.

In an embodiment, the destination node is an intended destination node, and wherein the communication hub changes the communication interface based on the intended destination node.

In an embodiment, the communication hub changes the communication interface based on at least one of the plurality of medical devices from which the plurality of communications originated.

In an embodiment, communication hub is disclosed for use in a system having a plurality of medical devices configured to transmit a plurality of communications containing information affecting priority of transmission of data from at least one of the plurality of medical devices. The communication hub comprises a communication module configured to receive the plurality of communications from the medical devices, determine a priority of transmission of the data from the plurality of communications based, at least in part, on the information affecting priority, and transmit the data from one of the plurality of medical devices by way of a network to a destination node in an order based, at least in part, on the priority of transmission

In an embodiment, a device implemented method of obtaining and distributing data from at least one of a plurality of medical devices, comprising the steps of transmitting a plurality of communications from the plurality of medical devices to a communication hub, each of the plurality of communications containing information affecting priority of transmission of data from an associated one of the plurality of medical devices, receiving the plurality of the communications from the plurality of medical devices with the communication hub, determining a priority of transmission of the data from the plurality of communications based, at least in part, on the information affecting priority, and transmitting the data from the communication hub to a destination node in an order based, at least in part, on the priority of transmission from the determining step.

In an embodiment, at least one of the plurality of medical devices is an implantable medical device and the method further comprises the step, before the transmitting the plurality of communications step, of implanting the implantable medical device in a patient.

In an embodiment, at least some of the plurality of medical devices are implantable medical devices and the method further comprises the step of implanting the implantable medical devices in a plurality of patients, each implantable medical device being implanted in only one patient at a time.

### FIGURES

FIG. 1 is a diagram of a system including a hub;

FIG. 2 is a block diagram of the hub of FIGS. 1; and

FIG. 3 is a flowchart for obtaining and distributing data from a medical device.

### DESCRIPTION

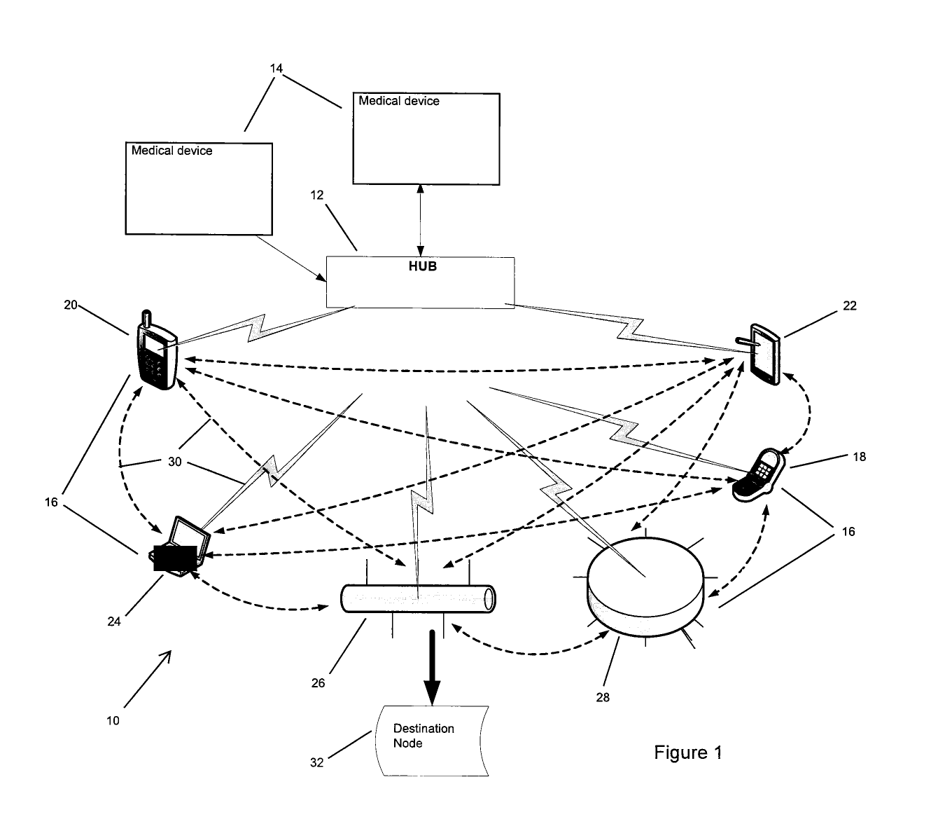

FIG. 1 is an embodiment of system 10 which incorporates hub 12, medical devices 14 and peripheral devices 16. In certain embodiments, system 10 functions at least in part as a conventional information network. In various embodiments, the functionality of various components 12, 14, 16 of system 10 are combined as a single component. So, for instance, hub 12 or peripheral devices 16 may also be a medical device 14. Peripheral devices 16 include, in various embodiments, cellular telephone 18, smartphone 20, personal digital assistant 22 and personal computer 24. In addition, peripheral devices may include devices which are configured to link with other devices, such as network port 26, in an embodiment, an Ethernet port. Further, peripheral devices may incorporate additional networks 28, in an exemplary embodiment a ring networks but including other networks known in the art.

Medical devices 14 include various devices known in the art. As illustrated, medical device 14 is an implantable medical device as known in the art, including a pacemaker, defibrillator, neurological stimulator or drug pump. Such devices are commonly implanted and associated with only one patient at a time, while a single patient may be implanted with multiple such medical devices 14. Other medical devices known in the art may also be included, including external devices such as physician and patient programmers, drug pumps, blood pressure monitors, dialysis machines and the like. Some such devices may be associated with only one patient at a time, while other devices, such as programmers and diagnostic devices may be associated with multiple patients at a time. Further, peripheral devices including, but not limited to smartphone 20, personal digital assistant 22 and personal computer 24 are configurable as medical devices 14, particularly when such devices are supplemented with software or hardware to provide medical functionality.

Hub 12 is configured to communicate with medical devices 14 and peripheral devices 16. Such communications 30 may be wired or wireless as circumstances dictate or permit. In various embodiments, hub 12 is configured to communicate with some or all of medical devices 14 and peripheral devices 16 according to at least one of inductive telemetry, wireless telemetry such as over the Medical Implant Communications Service and Medical Electronic Data Service or MICS/MEDS bands, the 802.11 WiFi standard and Bluetooth. In various embodiments, hub 12 is configured to select among various communication standards dependent on a type of data; relatively urgent data or limited amounts of data may be transmitted with a standard which has high reliability or bandwidth but also high power consumption, while large amounts of relatively non-urgent data may be transmitted according to standards with low bandwidth but low power consumption. In addition, a communication standard may be selected dependent on the type of medical device 14 from which a communication originated or other device 14, 16 or destination node with which hub 12 is communicating; standards may be selected which conform with the capabilities of the device with which communication is occurring. In various embodiments, hub 12 is configured to communicate via modem or Ethernet. In additional embodiments, communications occur via the Internet.

In various embodiments, hub 12 is an external device configured to be placed in a clinical setting and interface with medical devices 14 and peripheral devices 16 which come within communication range of hub 12. In an embodiment, hub 12 is a standalone external device. In alternative embodiments, the functionality of hub 12 is distributed among various devices in system 10. In various embodiments, hub 12 is a personal computer supplemented with wireless communication capabilities, such as by interfacing with a wireless router or the like. Alternatively, hub 12 is a proprietary device with computational and communications capabilities sufficient to meet the requirements of hub 12 described herein and as would be apparent to one of ordinary skill in the art. Further alternatively, hub 12 may be incorporated into an implantable medical device, a laptop computer or other mobile device. In such circumstances, system 10 may be geographically mobile relative to movement of hub 12.

Hub 12 is configured to maintain a table comprised of the membership of system 10 at any given time. Medical devices 14 and peripheral devices 16 may be configured to enter and leave system 10 as they come within communication range of hub 12. As such, system 10 may change dynamically, with hub 12 being configured to recognize when a device 14, 16 enters or leaves system 10 and factor that information into hub's 12 considerations for the transmission of information. In the case of wired devices or devices coupled to the Internet, such devices may be part of system 10 without regard to spatial proximity to hub 12.

Communication within system 10 may proceed in a manner consistent with standard networking protocols. On the basis of availability of a particular medical device 14 or peripheral device 16, or the availability of a communication link 30 between or among hub 12, medical device 14 or peripheral device 16, hub 12 may transmit information to or via different devices 14, 16. In such circumstances, one device 14, 16 may function as a relay to an ultimate destination. In particular, in certain embodiments, hub 12 may communicate with network port 26 when then communicates via the Internet to destination node 32 such as a central database for data storage and analysis. In various embodiments, destination node 32 is a component of system 10.

It is noted that any device 14, 16 within system may be destination node 32 for medical device 14 information, and that any device outside of system 10 but which may be in communication with system 10 via a network or the Internet may be destination node 32 for medical device 14 information. In such circumstances, hub 12 may be configured to discriminate between and among different destinations and send the medical device information to the appropriate destination.

As noted above, hub 12 is configured to receive communications from medical devices 14. Such communications may include various types of information, including patient data of various degrees of urgency or priority. For instance, such communications may include relatively low priority information such as an average heart rate or electrogram, blood pressure, blood glucose level or weight, or may include relatively high priority information such as an indication of cardiac fibrillation or cardiac death. Such priority or urgency is not binary and may include gradations between being high priority and low priority.

Medical device 14 communications may further include information relating to a status or performance of medical device 14 itself, again with varying degrees of priority. Relatively low priority information may include a status report indicating that medical device 14 is performing properly and within design limitations. Relatively high priority information may include imminent battery depletion or detected malfunctions. Medical device 14 communications may further include additional information which may incorporate priority factors, such as, but not limited to medical device 14 identification information including device make and model and an identity of a manufacturer of medical device 14, such as for the purpose of device identification or recall information and the like.

On the basis of the priority of the medical device 14 communications, hub 12 is configured to determine a priority of transmission for the medical device 14 communication to destination node 32. Various methodologies for determining an overall priority of a medical device 14 communication may be applied. In an embodiment, the nature or type of the medical device 14 communication may be compared against known conditions, either in medical device 14 or in hub 12. For instance, a status report indicating that medical device 14 is operating within normal parameters or a report of a patient's weight may be automatically assigned an importance of “1” on a ten-point scale according to a look-up table. A communication indicating that medical device 14 has a battery with less than ten percent remaining charge may be assigned an importance of “6”, while a communication indicating that the patient is experiencing sudden cardiac death may be assigned an importance of “10”. A communication with multiple pieces of information, each with a different importance, may be assigned an overall importance equivalent to the highest importance of each individual one of the various pieces of information.

In various embodiments, in lieu of or in addition to automatic importance assignments, alternative factors for identifying importance of medical device 14 communications may be utilized. In an embodiment, a user may designate an importance for medical device 14 communications. In the event the user is a medical professional, the designation may supersede an automatically-designated importance. Where the user is not a medical professional, in certain embodiments the user input may supplement, rather than replace, the automatic importance assignment. An authorization of a user at the originating medical device 14 may provide an indication of priority of transmission by a sender of the communication.

In a further alternative, where nature of the destination node may impact the importance of medical device 14 communications. Where destination node 32 is a database having merely storage or analytic capabilities, priority may be increased. Where the destination node is an emergency responder or emergency call center, for instance, importance may be increased. It is noted that destination node identity may be a supplement to the urgency or lack thereof of the medical device 14 communication; information which may tend to go to an emergency call center may already have a high urgency, while information that is merely stored in a database may already have a low urgency. However, certain destinations, such as follow-up clinics and operating rooms, may have a relatively greater urgency owing to a need to quickly and efficiently conduct a patient procedure.

On the basis of the assigned priority, hub 12 determines a priority of transmission for the medical device 14 communication. Thus, an importance “10” communication may receive the highest priority of transmission while the importance “1” communication may receive the lowest priority of transmission. Consequently, hub 12 is configured to transmit the communications to destination node 32 on the basis of the communications' importance of transmission. In an embodiment, the highest priority data may be transmitted first, followed by a next highest priority data transmission, and so on. Thus, an importance “10” communication may receive the highest priority of transmission and be transmitted prior to the importance “1” communication.

In various embodiments, the conduction of transmission of medical device 14 communications may be according to various transmission schemes. Thus, the highest priority transmission may be transmitted in full, following which an assessment of the remaining messages may be made to identify the remaining message with the highest priority of transmission, at which point that highest priority communication is transmitted in full, and so forth. Alternatively, hub 12 may continually assess priority of transmission of all communications pending transmission, and whatever message at any given time has the highest priority of transmission is the message that hub 12 sends at that time. Consequently, if hub 12 were in the process of transmitting a message with an importance of “9” and an importance“10” message arrived for transmission, transmission of the importance “9” may be suspended and transmission of the importance “10” message begun forthwith. Transmission of the importance “9” message may resume upon the completion of the importance “10” message, unless another message arrived which would superseded the importance “9” message.

In embodiments in which transmission bandwidth exists adequate to transmit multiple messages concurrently, the highest priority messages are selected for transmittal, and as each transmission completes, transmission of a subsequent message begins. In various embodiments, where bandwidth permits multiple transmissions concurrently, but where a single message may be transmitted more rapidly if other transmissions were suspended, criteria may be established for the suspension of concurrent transmission and the devotion of all bandwidth to a single transmission. For instance, an importance “10” message may supersede all other concurrent transmissions, and concurrent transmission may begin again after completion of transmission of the importance “10” message.

In addition, relative priority of transmission may change over time. For instance, in the event of relatively high numbers of medical device 14 communications over a relatively short period of time, the bandwidth of communications 30 of system 10 may become overloaded and bogged down. In such circumstances, relatively low importance communications may languish unsent for extended periods of time. However, it may be the case that such information is still necessary for the effective treatment of the patient or management of medical device 14. Thus, over the passage of time the priority of transmission for any one medical device 14 communication may rise. Thus, an importance “1” communication may progressively rise in priority of transmission to the point where the priority of transmission of the importance “1” communication exceeds that of a importance “2” or “3” communication, and so on. Note that in such circumstances, relatively low importance communications may not be prioritized ahead of highly urgent communications. Thus, an importance “1” communication may not be prioritized ahead of an importance “8” communication regardless of how long the importance “1” communication has been waiting for transmission. In certain embodiments, a medical device 14 communication indicating extremely urgent importance may be transmitted at the earliest available opportunity.

In various embodiments, hub 12 is configured to incorporate other factors in addition to or in lieu of importance of the implantable medical device 14 communication in the determination of priority of transmission. In an embodiment, hub 12 is configured to assign priority of transmission based on a quality of communications links 30 over which the medical device 14 communication is to be transmitted to destination node 32. In certain circumstances, certain communication links 30, whether from medical device 14 to hub 12 or from hub 12 to different devices 14, 16, will have different quality of communication, such as bandwidth, data rate and reliability. In various embodiments, a communication capacity of hub 12 itself may factor in to a quality of communication of communication links 30.

Because different communication links 30 may have different properties, and because each medical device 14 communication may take a different path through system dependent on its ultimate destination, certain medical device 14 communications may be more likely or able to reach their intended destination node than other medical device communications. Medical device 14 communications which pass through communication links 30 of relatively high quality may have a relatively higher priority of transmission than medical device 14 communications which pass through relatively low quality communication links 30. In so doing, hub 12 may focus system 10 resources on communication links 30 with relatively high quality and not waste system 10 resources on trying to drive too many transmissions through relatively poor quality communication links 30.

In an embodiment, hub 12 transmits a first transmission, either a test transmission or an initial medical device 14 communication to obtain information relating to the quality of communication links 30 over which subsequent medical device 14 communications may travel. On the basis of the quality of communication links 30 as determined by the first transmission, a second and subsequent medical device 14 communication transmissions may be prioritized.

In certain embodiments, a quantity of information in each medical device 14 communication may impact priority of transmission. Relatively large communications may be more taxing on system 10 resources and therefore be prioritized relatively lower, particularly until system 10 resources are relatively underutilized. In certain embodiments, hub 12 may break up relatively large medical device 14 communications, either transmitting the messages in smaller parts so as not to dominate system 10 resources, or to transmit a subpart of the medical device 14 communication, such as a summary or particularly critical data in contrast with relatively less critical data. The un-transmitted portion of the communication may, in various embodiments, be transmitted at a later time or discarded according to various criteria.

Various embodiments of hub 12 and devices 14, 16 of system 10 may have limited power supplies. In particular, such devices 12, 14, 16 may be battery powered. Medical devices 14, and notably implantable medical devices, are commonly battery powered, and power consumption is often a significant consideration for such devices. In an embodiment, priority of transmission is based on availability of power. In particular, devices 12, 14, 16, and especially medical devices 14, may factor in a need to conserve power in assigning priority of transmission. Battery powered devices 12, 14, 16 may collect information for communication and then transmit such information in a single, power-efficient large burst of data with high priority to provide rapid transmission and therefore efficient power consumption.

Network security is, in many embodiments, an important factor, and may impact a priority of transmission. Communications with highly sensitive information may be prioritized highly when network security is evaluated as being high, such as when highly secure devices 14, 16 are introduced to system 10 to create particularly secure communication links 30. Communications with relatively low sensitivity may be prioritized at a low level when security is high. Conversely, when highly secure devices 14, 16 are not available to system 10, low-sensitivity information may be prioritized highly while high-sensitivity information may be prioritized at a low level.

Communications to and from hub 12 may take a variety of different forms. Common formats such as electronic mail, electronic text, audio and video may be utilized in manners known in the art. Within such formats, particular messages may be included. In an embodiment, communications include alert messages. Such alert messages may be rated of high importance. Such alert messages may be designed for particular destination nodes. In an embodiment, an alert message may be formatted for reception by a destination node associated with a medical professional, such as a clinic or hospital. In an embodiment, an alert message may be formatted for reception by a destination node associated with a caregiver of a patient, such as a home or office of an acquaintance or relative of the patient. The alert messages may contain information pertinent to the recipient, such as the identity of the sender, the location of the sender and relevant information which caused the alert to be sent.

System 10 is configured so that communication links 30 and hub 12 are configured to provide communications back to a medical device 14 from a destination node 32. In particular, destination node 32 may transmit a confirmation message to acknowledge receipt of a transmission. In various embodiments, destination node 32 or a device 14, 16 within system may be utilized to transmit programming instructions to medical device 14 to reprogram medical device 14 or to command the transmission of more or different data. In particular, such a programming instruction or command may include stopping a false alert message, stopping an improper therapy delivery and configuring medical device 14 into a safe operation mode to protect, at least in part, medical device 14 from an environmental condition, such as a powerful electromagnetic field or abnormal temperatures.

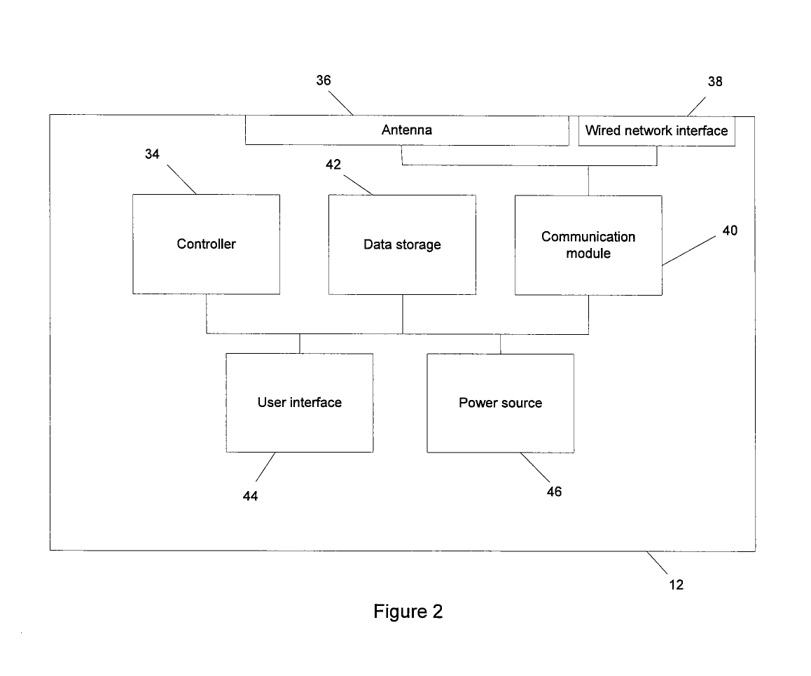

FIG. 2 is a block diagram of hub 12. Controller 34 is, in various embodiments, a commercial off-the-shelf microprocessor or other commercially-available processor or controller. Alternatively, controller 34 is a proprietary chipset designed for use in hub 12. Controller 34 is configured to provide general control functionality for hub 12, including determining priority of transmission for incoming medical device 14 communications and communications within system 10 in general.

Antenna 36 variably includes any antenna architecture needed to communicate wirelessly within system 10. In various embodiments, a single antenna may be utilized, either from an off-the-shelf part or a custom part, to communicate across multiple bands and standards, as is known in the art. In an embodiment, different antennas are utilized for different bands and standards. In an embodiment, hub 12 incorporates an antenna for communicating via Bluetooth and at least one different antenna for communicating via 802.11 WiFi. Further, antenna 36 variably incorporates one or more proprietary antennas for communicating with medical devices 14, including inductive coils and antennas for communicating over the MICS/MEDS bands.

In the illustrated embodiment, hub 12 further incorporates wired network interface 38. In alternative embodiments, hub 12 does not incorporate wired network interface 38. In an embodiment, wired network interface 38 includes at least one Ethernet port. In an embodiment, wired network interface 38 includes a telephone jack. In various embodiments, wired network interface 38 includes other wired networking standards as known in the art.

Communication module 40 is configured to interface with controller 34, antenna 36 and wired network interface 38 to facilitate network communications in system 10. In an embodiment, communication module 40 operates according to conventional networking protocols well known in the art. In further embodiments, communication module 40 operates according to proprietary networking protocols and proprietary medical device communication schemes.

Hub further includes data storage 42. In various embodiments, data storage 42 is a hard drive or random access memory. Data storage 42 is configured to store received communications and priority information until such time as the received communications are transmitted via communication module 40.

In various embodiments, hub 12 incorporates user interface 44, such as a touch screen or a display and keyboard combination. In various embodiments, hub 12 incorporates power source 46, in various embodiments supplied from an external source or an internal battery.

As noted above, various embodiments of hub 12 are standalone. In such embodiments, hub 12 as depicted is contained within a single unit, which is to say a single housing incorporating the primary hardware, with the exception, in various embodiments, of antennas which of necessity must be placed in close proximity of another antenna, such as an inductive coil. Alternatively, the hardware of hub 12 may be distributed among different platforms. In various embodiments, controller 34 and data storage 42 may be in one unit, such as a personal computer, a tablet or a smartphone, while antenna 36, wired network interface 38 and communication module 40 may be incorporated within a separate communication device, such as a network router, which is operatively coupled to the personal computer. In the above examples, hub 12 is an external device and not configured to be implanted within a patient. However, in various embodiments, hub 12 may be configured as an implantable medical device, with at least some of the hardware blocks of hub 12 being in the implantable device.

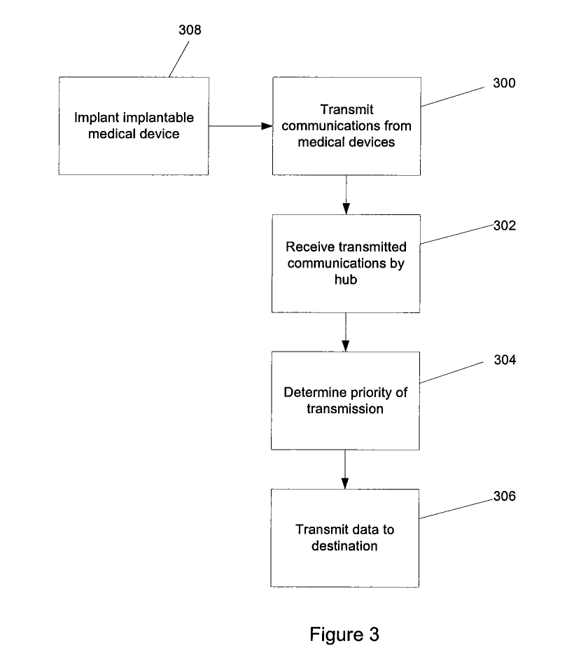

FIG. 3 is a flowchart for obtaining and distributing data from a plurality of medical devices. A plurality of communications are transmitted (300) from medical devices 14 to hub 12. In an embodiment, the communication is received by way of at least one of antenna 36 and wired communication module 38 and by communication module 40. Each of the communications contains information affecting priority of transmission of the data, as discussed in detail above. The information affecting priority of transmission may include the importance factor among other factors as described above.

Hub 12 receives (302) the transmitted communications from medical devices 14 and, in an embodiment, stores the communications in data storage 42. Hub 12 determines (304) a priority of transmission for each communication. In an embodiment, controller 34 determines the priority of transmission. In an embodiment, the priority of transmission is stored in data storage 42, in an embodiment with the association communication. The priority of transmission is determined, at least in part, based on the information affecting priority of transmission from each communication, as well as additional factors as discussed in detail above.

Hub 12 then transmits (306) the data from the medical device 14 communication to destination node 32 by way of communication links 30, in various embodiments via medical devices 14 and peripheral devices 16 of system 10. In an embodiment, communication module 40 transmits the data to communication links 30 via at least one of antenna 36 and wired communication module 38. Transmission of medical device 14 data to destination node 32 occurs according to the processes as described in detail above.

In various embodiments, medical device 14 is an implantable medical device. In such embodiments, implantable medical device may be communicated with prior to implantation. In various embodiments, implantable medical device 14 is implanted (308) in a patient prior to the transmitting (300) step.

Thus, embodiments of the memory with selectively writable error correction codes and validity bits and method are disclosed. One skilled in the art will appreciate that the present invention can be practiced with embodiments other than those disclosed. The disclosed embodiments are presented for purposes of illustration and not limitation, and the present invention is limited only by the claims that follow.

What is claimed is:

1. A system, comprising:
a plurality of medical devices configured to transmit a plurality of communications containing information affecting priority of transmission of data from an associated one of said plurality of medical devices;
a destination node; and
a communication hub configured to:
receive said plurality of communications from said plurality of medical devices;
determine a priority of transmission of said data from said plurality of communications based, at least in part, on said information affecting priority; and
transmit said data from one of said plurality of medical devices by way of a network to said destination node in an order based, at least in part, on said priority of transmission.

2. The system of claim 1 wherein said priority of transmission is based, at least in part, on an importance of communication of said data from each of said plurality of medical devices.

3. The system of claim 1 wherein said priority of transmission is based, at least in part, on a quality of a communication signal over which said communication hub transmits said data.

4. The system of claim 3 wherein said communication hub is configured to transmit a first communication signal having said quality of said communication signal and a second transmission after said first transmission, and wherein said priority of transmission is determined for said second transmission based on said quality of said first communication signal.

5. The system of claim 1 wherein said priority of transmission is based, at least in part, on a type of said data.

6. The system of claim 1 wherein said priority of transmission is based, at least in part, on a quantity of said data.

7. The system of claim 6 wherein said communication hub is further configured to transmit only a subset of said data from said one of said plurality of medical devices based on said priority of transmission.

8. The system of claim 1 wherein said priority of transmission is based, at least in part, on available power.

9. The system of claim 8 wherein said available power is based, at least in part, on an amount of power in a battery of a corresponding one of said plurality of medical devices.

10. The system of claim 1 wherein said priority of transmission is based, at least in part, on an authorization of a sender of said plurality of communications.

11. The system of claim 1 wherein said priority of transmission is based, at least in part, on a security of said plurality of communications.

12. The system of claim 1 wherein said plurality of communications are at least one of electronic mail, electronic text and audio.

13. The system of claim 12 wherein said plurality of communications include, at least in part, an alert message.

14. The system of claim 1 wherein said destination node is configured to respond to said plurality of communications with at least one of a confirmation message and a command to alter a configuration of at least one of said plurality of medical devices.

15. The system of claim 1 wherein said communication hub changes said communication interface based on a type of said data.

16. The system of claim 1 wherein said communication hub changes said communication interface based on an urgency of said data.

17. A communication hub for use in a system having a plurality of medical devices configured to transmit a plurality of communications containing information affecting priority of transmission of data from at least one of said plurality of medical devices, comprising a communication module configured to:
receive said plurality of communications from said medical devices;
determine a priority of transmission of said data from said plurality of communications based, at least in part, on said information affecting priority; and
transmit said data from one of said plurality of medical devices by way of a network to a destination node in an order based, at least in part, on said priority of transmission.

18. The communication hub of claim 17 wherein said priority of transmission is based, at least in part, on an importance of communication of said data from each of said plurality of medical devices.

19. The communication hub of claim 17 wherein said priority of transmission is based, at least in part, on a quality of a communication signal over which said transmit said data function occurs.

20. The communication hub of claim 19 further configured to transmit a first communication signal having said quality of said communication signal and a second transmission after said first transmission, and wherein said priority of transmission is determined for said second transmission based on said quality of said first communication signal.

21. The communication hub of claim 19 wherein said quality of said communication signal is based, at least in part, on a data rate of said communication signal.

22. The communication hub of claim 19 wherein said quality of said communication signal is based, at least in part, on an available bandwidth of said communication signal.

23. The communication hub of claim 19 wherein said quality of said communication signal is based, at least in part, on a communication capability of at least one of said plurality of medical devices.

24. The communication hub of claim 19 wherein said quality of said communication signal is based, at least in part, on a communication capability of said external communication hub.

25. The communication hub of claim 17 wherein said priority of transmission is based, at least in part, on a type of said data.

26. The communication hub of claim 17 wherein said priority of transmission is based, at least in part, on a quantity of said data.

27. The communication hub of claim 17 wherein said priority of transmission is based, at least in part, on available power.

28. The communication hub of claim 27 wherein said available power is based, at least in part, on an amount of power in a battery of a corresponding one of said plurality of medical devices.

29. The communication hub of claim 17 wherein said priority of transmission is based, at least in part, on an authorization of a sender of said plurality of communications.

30. The communication hub of claim 17 wherein said priority of transmission is based, at least in part, on a security of said plurality of communications.

31. The communication hub of claim 17 wherein said communication hub changes said communication interface based on a type of said data.

32. The communication hub of claim 17 wherein said communication hub changes said communication interface based on an urgency of said data.

33. A device implemented method of obtaining and distributing data from at least one of a plurality of medical devices, comprising the steps of:
transmitting a plurality of communications from said plurality of medical devices to a communication hub, each of said plurality of communications containing information affecting priority of transmission of data from an associated one of said plurality of medical devices;
receiving said plurality of said communications from said plurality of medical devices with said communication hub;
determining a priority of transmission of said data from said plurality of communications based, at least in part, on said information affecting priority; and
transmitting said data from said communication hub to a destination node in an order based, at least in part, on said priority of transmission from said determining step.

34. The method as in claim 33 wherein said communication hub is an external communication hub.

35. The method as in claim 33 wherein said communication hub is one of said plurality of medical devices.

36. The method of claim 33 wherein at least one of said plurality of medical devices is an implantable medical device and further comprising the step, before said transmitting said plurality of communications step, of implanting said at implantable medical device in a patient.

37. The method of claim 36 wherein at least some of said plurality of medical devices are implantable medical devices and further comprising the step of implanting said implantable medical devices in a plurality of patients, each implantable medical device being implanted in only one patient at a time.

38. The method of claim 37 wherein said priority of transmission is based, at least in part, on an importance of communication of said data from each of said plurality of implantable medical devices.

39. The method of claim 38 wherein said priority of transmission is based, at least in part, on a quality of a communication signal over which said transmitting step occurs.

40. The method of claim 37 wherein said priority of transmission is based, at least in part, on a type of said data.

41. The method of claim 37 wherein said priority of transmission is based, at least in part, on a quantity of said data.

42. The method of claim 37 wherein said priority of transmission is based, at least in part, on available power.

43. The method of claim 42 wherein said available power is based, at least in part, on an amount of power in a battery.

44. The method of claim 43 wherein said battery is associated with at least one of said plurality of medical devices.

45. The method of claim 37 wherein said priority of transmission is based, at least in part, on an authorization of a sender of said plurality of communications.

46. The method of claim 37 wherein said priority of transmission is based, at least in part, on a security of said plurality of communications.

47. The method of claim 37 wherein said plurality of communications include, at least in part, an alert message.

48. The method of claim 37 wherein said plurality of communications include at least one of an identification of at least one of said plurality of medical devices and a manufacture of at least one of said plurality of medical devices.

49. The method of claim 37 wherein said destination node is configured to respond to said plurality of communications with at least one of a confirmation message and a command to alter a configuration of at least one of said plurality of medical devices.

50. The method of claim 37 wherein said communication hub has a communication interface for transmitting said data comprising at least one of Bluetooth and WiFi.

51. The method of claim 50 wherein said communication hub changes said communication interface based on a type of said data.

52. The method of claim 50 wherein said communication hub changes said communication interface based on an urgency of said data.

53. The method of claim 50 wherein said communication hub changes said communication interface based on said destination node.

54. The method of claim 50 wherein said communication hub changes said communication interface based on at least one of said plurality of medical devices from which said plurality of communications originated.
